(19) United States
(12) Patent Application Publication
(10) Pub. No.: US 2019/0184883 A1
(43) Pub. Date: Jun. 20, 2019

(54) Leg Rest Device

(71) Applicant: Jing ZHONG, La Puente, CA (US)

(72) Inventor: Jing ZHONG, La Puente, CA (US)

(21) Appl. No.: 15/847,838

(22) Filed: Dec. 19, 2017

(51) Int. Cl. B60N 2/90; B60N 2/26

(52) U.S. Cl. CPC B60N 2/995; B60N 2/26

(57) ABSTRACT

A leg rest device includes a top wall, a bottom wall and a surrounding side wall extended between the top wall and the bottom wall to form a receiving cavity therein for receiving filling material. When the receiving filling materials are filled with filling material, the leg rest device forms a space-structure body sized to fit in a gap formed between the front row seats and back row seats of a vehicle to provide leg support for a user.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to leg rest device and more particularly to a leg rest device with adjustable height arrangement.

### Description of Related Arts

The most harassment of long trips is that people should sit on a seat for a long time to wait to arrive in their destination. In order to save energy or kill time, most people choose to sleep, read books or watch videos during sitting on their seats. But such prolong sitting always causes back pains, poor blood circulation, swellings, which make people feel very uncomfortable and generally couldn't fall asleep nor focus on books and videos. For the parents with young children, it is almost a terrible dream to bring their young children on a long trip, especially when the children are too young to have their own seats. Because the long trip on a plane, on a train or in a car often make the young children feel dull and uncomfortable, which may result with terrible crying that causes great annoying to the parents and other passengers.

Even though the child has his or her own seat, the size of the seat is designed for an adult to sit but not a child to lay down to sleep. So that to those parents who try their best to comfort their young children to make them fall asleep to get a relatively peaceful trip. The seats on the plane, the train or the car may only fit a baby to sleep thereon, but for an elder young child, the seats are too small for them to lie down to sleep. The best would be enabling the child to uncomfortably curl up on a chair which shall not help the young children falling asleep. Except that, even if the seat in a car is big enough for a young child sleep thereon, the gap between the front row seats and the back row seats is a hazard to the parents that, if the sleeping young child turns over on the seat or the driver makes an urgent brake or turn, the sleeping young child will easily fall down from the seat into the gap and cause injury to the child.

### SUMMARY OF THE PRESENT INVENTION

The invention is advantageous in that it provides a leg rest device which is able to construct selectively to form a space-structure body when it is filled with filling materials, wherein the leg rest device filled with filling materials is adapted for being placed and filled the gap between the front row seats and the back row seats in a vehicle to provide a support for a user's legs or create a resting platform providing a relatively flat resting surface with the back row seat for young children.

Another advantage of the invention is to provide a leg rest device which overall height is adjustable according to different needs.

Another advantage of the invention is to provide a leg rest device, wherein the air inflated therein is able to be drained out when the leg rest device is not used, and thus the leg rest device is capable of being folded up for storing and being carried around conveniently.

Another advantage of the invention is to provide a leg rest device, wherein the leg rest device comprises two or more leg rest bodies which can be detachably connected to form an integral leg rest body to provide an elevated supporting top surface and a higher height for the user to meet his or her requirement according to the resting environment of the user, wherein, in one embodiment, both the leg rest bodies are made inflatable so that the overall height of the integral leg rest body is adjustable by controlling the amount of air inflated into the two leg rest bodies respectively.

Additional advantages and features of the invention will become apparent from the description which follows, and may be realized by means of the instrumentalities and combinations particular point out in the appended claims.

In accordance with one aspect of the invention, the leg rest device of the present invention comprises at least a leg rest body which has a top wall, a bottom wall, a surrounding side wall extended between the top wall and the bottom wall to form a receiving cavity therein for receiving filling materials, an opening for a filling material passing therethrough into the receiving cavity, and a stopper selectively controlling the filling material filling in and out of the receiving cavity. When the receiving cavity is filled with the filling material, the leg rest device shall form a space-structure body as a supporting platform for the user. When the filling material is drained out of the receiving cavity, the leg rest device is adapted for being folded up for storing and carrying.

In accordance with another aspect of the invention, leg rest device of the present invention comprises a base leg rest body and an auxiliary leg rest body adapted to be connected with the base rest body to form an integral leg rest body to form an integral leg rest body to provide an elevated supporting top surface and a higher height for the user to meet his or her requirement according to the resting environment of the user.

In one embodiment, the base leg rest body has a base receiving cavity therein for receiving a filling material and the auxiliary leg rest body has an auxiliary receiving cavity therein for receiving the filling material therein.

In one embodiment, the connection between the base leg rest body and the auxiliary leg rest body is detachable so that the user may select to use one of the base leg rest body and the auxiliary leg rest body or both the connected base leg rest body and auxiliary leg rest body to adjust the overall height of the leg rest device of the present invention. In addition, the amount of the filling material to be filled in said base receiving cavity and the auxiliary receiving cavity may further adjust and control the overall height of the leg rest device. In other words, when a user need a higher support, the base leg rest body and the auxiliary leg rest body are filled with the filling material to form two space-structure bodies respectively which are able to be stacked together to form the integral leg rest body to provide the high support, and that when the user needs a low support, the base leg rest body and the auxiliary leg rest body can be selectively filled with less filling material to form the integral leg rest body which is a combined space-structure body to provide corresponding support for the user.

In one embodiment, both the leg rest bodies are made inflatable and the filing material is air, so that the overall height of the integral leg rest body is adjustable by controlling the amount of air inflated into the two leg rest bodies respectively

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a leg rest device according to a first preferred embodiment of the present invention.

FIG. 2 is a front view of the leg rest device according to the first preferred embodiment of the present invention.

FIG. 3 is a sectional perspective view of the leg rest device according to the first preferred embodiment of the present invention.

FIG. 4 is a perspective view with an enlarged diagram illustrating a stopper of the leg rest device, in opened state, according to the first preferred embodiment of the present invention.

FIG. 5 is a perspective view illustrating the stopper of the leg rest device, in closed state, according to the first preferred embodiment of the present invention.

FIG. 6 is a schematic view of a leg rest device according to a second preferred embodiment of the present invention.

FIG. 7 is a perspective view of the leg rest device according to the second preferred embodiment of the present invention.

FIG. 8 is a perspective view of the leg rest device according to an alternative mode of the second preferred embodiment of the present invention.

FIG. 9 is a perspective view of the leg rest device according to another alternative mode of the second preferred embodiment of the present invention.

FIG. 10 is a sectional perspective view of the leg rest device according to the second preferred embodiment of the present invention.

FIG. 11 is a schematic view of a leg rest device according to a third preferred embodiment of the present invention.

FIG. 12 is a sectional perspective view of the leg rest device according to the third preferred embodiment of the present invention.

FIG. 13 is a schematic view of the leg rest device, in a first semi-inflated state, according to the third preferred embodiment of the present invention.

FIG. 14 is a schematic view of the leg rest device, in a second semi-inflated state, according to the third preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

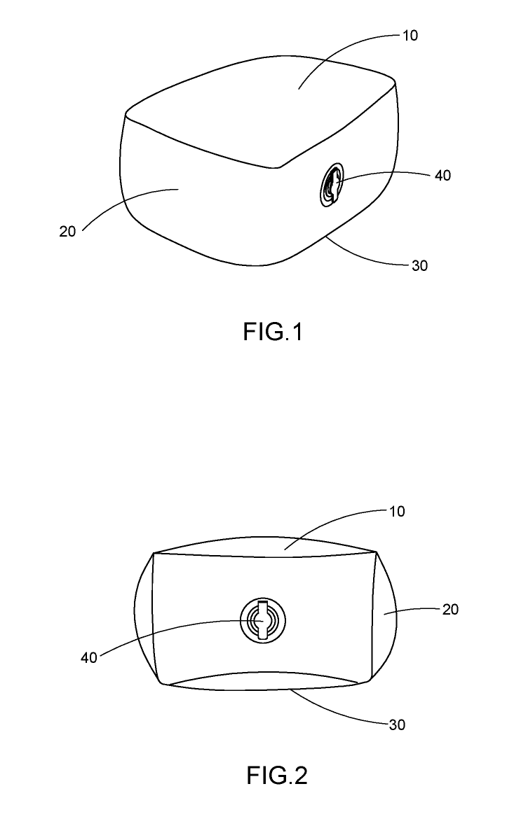

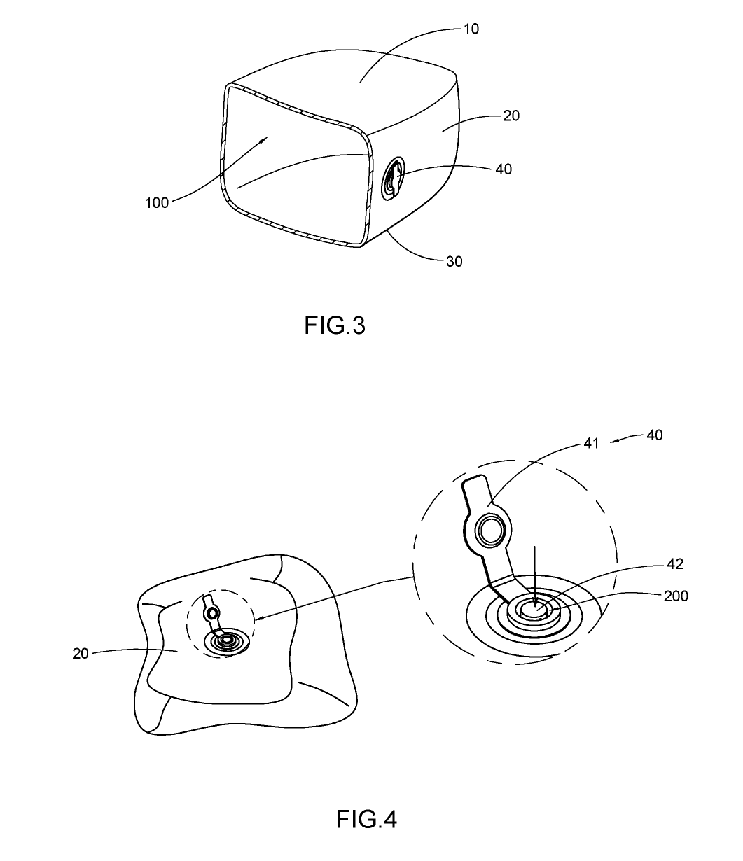

As shown in FIG. 1 to FIG. 5, a leg rest device according to a first preferred embodiment of the present invention is illustrated, wherein the leg rest device comprises at least a leg rest body 1 which has a top wall 10, a bottom wall 30 and a surrounding side wall 20 extended between the top wall 10 and the bottom wall to define at least a receiving cavity 100 formed therein for receiving at least a filling material. It is worth to mention that the filling material can be air, water, particles, and so on.

According to the first preferred embodiment, the leg rest device is adapted for being air inflated by the user with mouth or an air pump. In other words, when the user wants to use the leg rest device, she or he can inflate it with the mouth anytime without the aid of other instruments which make the usage of the leg rest device more convenient.

Preferably, the top wall 10, the bottom wall 30 and the surrounding side wall 20 are integrally made to form the leg rest body 1. In other words, the top wall 10, the bottom wall 30, and the surrounding side wall 20 can also be separately made and connected with each other edge to edge together to form the integral leg rest body 1 and define the receiving cavity 100 therein.

The leg rest device further has an opening 200 for the filling material passing therethrough and a stopper 40 for controlling the opening of the opening 200 for the filling material to fill into or out of the receiving cavity 100 and the closing of the opening 200 for preventing and sealing the filling material from coming out of the receiving cavity 100. According to the first preferred embodiment, the stopper 40 further comprises a controlling valve 42 provided at the opening 200 in such a manner that when the controlling valve 42 is pressed down by an external force to open, the controlling valve 42 allows the filling material selectively flowing into and out of the receiving cavity 100, and that when the controlling valve 42 is released to close, the controlling valve 42 is sealed to stop the filling material from flowing into or leaking from the receiving cavity 100 of the leg rest device. In order to enhance a tightness of the stopper 40, the stopper 40 further comprises a cover 41 which is detachably covered on the controlling valve 42 and a connecting arm 411. As shown in FIG. 4, the connecting arm 411 is connected between one end of the cover 41 and the controlling valve 42 so that when the cover 41 is opened, it remains connected to the controlling valve 42 through the connecting arm 411. It is worth to mention that, the stopper 40 is able to be embodied as other types of valves to control the inlet and outlet of the filling material, and the present invention should not be limited by this preferred embodiment.

As shown in FIG. 1 to FIG. 3, the leg rest device is embodied as a rectangular shape with a size preferably for being fittingly placed and filled the gap between the front row seats and the back row seats in a vehicle to provide a support for a user's legs or create a resting platform providing a relatively flat resting surface with the back row seat for young children. The leg rest device can be made in any other shape and size for use at home or office for being able to be steadily placed on the ground for the user to rest his or her legs thereon when sitting on a chair or sofa. It is worth mentioning that the filling material is preferred to be fluid material such as air or water so as to better conform and tightly fit into the gap between the front row seats and back row seats in the vehicle.

In addition, the leg rest device is able to be embodied as other shapes such as cylindrical shape, square shape, and etc.

According to the first preferred embodiment, the stopper 40 is made to allow the user to inflate the leg rest device by blowing air with mouth or an air pump, wherein when the user want to use the leg rest device, he or she can remove the cover 41 to blow air into the receiving cavity 100 through the controlling valve 42 by applying an air pressure on the controlling valve 42 to open the controlling valve 42, wherein when a predetermined amount of air has been inflated into the receiving cavity 100 to support the leg rest device to form the integral leg rest body 1 in desired shape with desired pressure, the inflation is finished. Then, the user can stop to blow the pressurized air in, wherein without the air pressure exerting on the controlling valve 42, the controlling valve 42 will close the opening 200 automatically so as to prevent the air in the receiving cavity 100 from flowing out. Finally, the user can cover the cover 41 of the stopper 40 on the controlling valve 42 to further enhance the tightness of the leg rest device. When the user wants to store the leg rest device, he or she is able to remove the cover 41 and press the controlling valve 42 down to open the opening 200 for the air deflating from the receiving cavity 100 and, after the air inflated in the receiving cavity 100 is drained out, the user can fold up the leg rest device for storing and carrying.

As show in FIG. 1 and FIG. 2, when the leg rest device is filled with the filling material to form the integral leg rest body, it is a space-structure body to provide a support for the user's leg, feet and can be placed in front of a seat or inserted into the gap between the front row seats and back row seats for leg resting or to create a flat platform with the adjacent seat surface, when the height of the leg rest body is about the height of the seat for the young child to lie down and sleep thereon while it also prevent the young children from falling down from the seat into the gap between the front row seats and the back row seats at the same time since such gap is filled with the leg rest device.

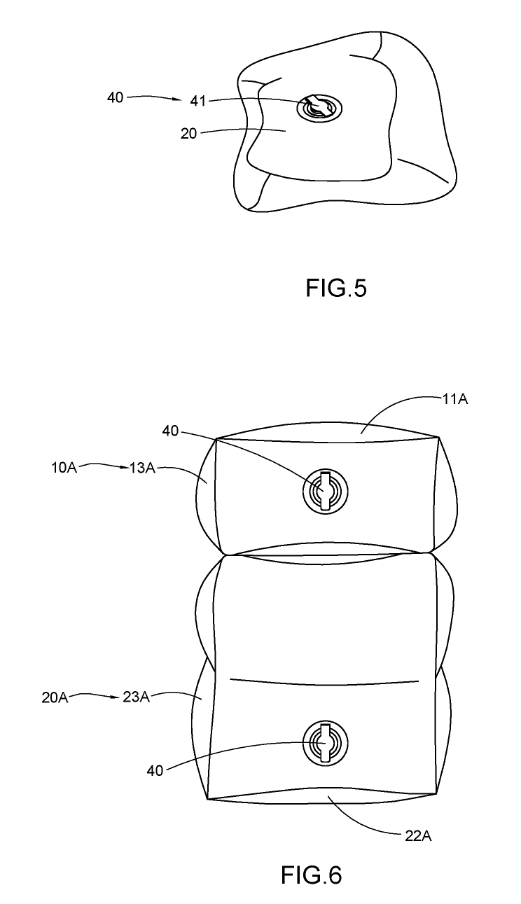

When the filling material is discharged from the receiving cavity 100 of the leg rest device as shown in FIG. 4 and FIG. 5, it is able to be folded up that takes a small space to be stored and is convenient and portable for the user to carry in a trip. It is worth to mention that the leg rest device is preferably made by foldable and airtight material, such as plastic, which are airtight and washable so that the leg rest device is able to be washed to keep clean from time to time. In addition, a soft material such as cloth, EVA, short nap, and etc. is preferred to be attached or coated on an exterior surface of the leg rest device to enhance the comfort of the leg rest device

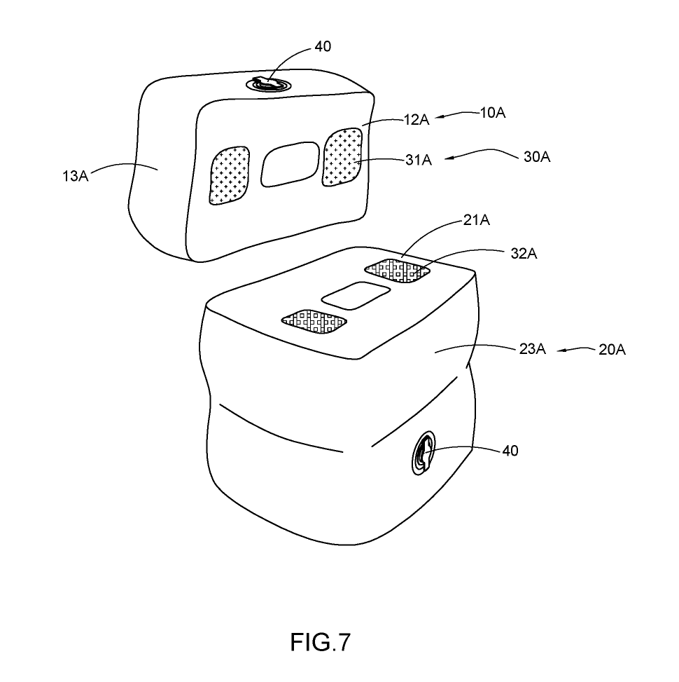

As shown in FIG. 6 to FIG. 10, a leg rest device according to a second preferred embodiment of the present invention is illustrated, wherein the height of the leg rest device is embodied as adjustable according to different needs. The leg rest device according to the second preferred embodiment further comprises an auxiliary leg rest body 20A beside the leg rest body 10A and a detachable securing means 30A adapted for detachably connecting the leg rest body with the auxiliary leg rest body 20A. Accordingly, when the user needs a higher support, the leg rest body 10A is able to be detachably connected with the auxiliary leg rest body 20A through the detachably securing means 30A to elevate the supporting height. Also, when the user needs a lower support, the user may simply use either the leg rest body 10A or the auxiliary leg rest body 20A independently after detaching the leg rest body 10A from the auxiliary leg rest body 20A, as shown in FIG. 7.

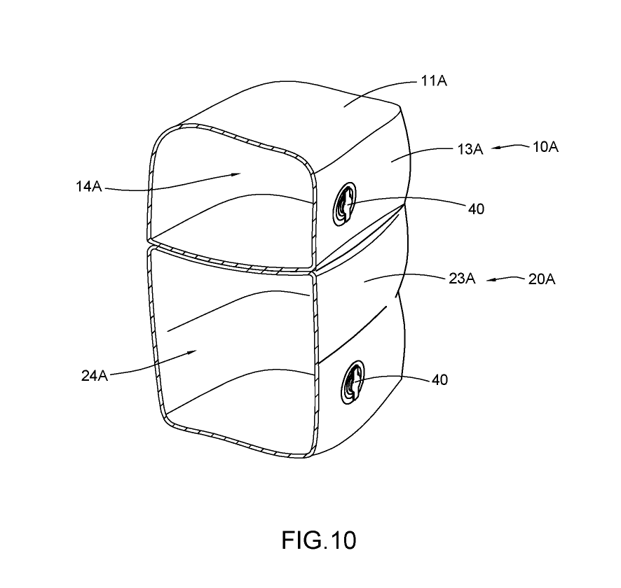

As shown in FIG. 7 and FIG. 10, the leg rest body 10A has a structure similar to the leg rest body 10 in the above first preferred embodiment that comprises a first top wall 11A, a first bottom wall 12A, and a first surrounding side wall 13A extended from the first top wall 11A to the first bottom wall 12A to form a first receiving cavity 14A therein for receiving filling material such as air, water, and other fluid material therein to form a first space-structure body having a first predetermined height, to provide a support for the user.

As shown in FIG. 7, the auxiliary leg rest body 20A has a structure similar to the leg rest body 10A with a second predetermined height higher than the first predetermined height, which comprises a second top wall 21A, a second bottom wall 22A, and a second surrounding side wall 23A extended from the second top wall 21A to the second bottom wall 22A to form a second receiving cavity 24A therein for receiving filling material such as air, water, and other fluid materials therein to form a second space-structure body to provide a support for the user.

Each of the leg rest body 10A and the auxiliary leg rest body 20A also has an opening 200 for the filling material passing therethrough and a stopper 40, as shown in FIG. 4, for controlling the opening of the opening 200 for the filling material to fill into or out of the first and second receiving cavities 14A, 24A and the closing of the opening 200 for preventing and sealing the filling material from coming out of the receiving cavities 14A, 24A. As shown in FIG. 4 and FIG. 10, similar to the first preferred embodiment, according to the second preferred embodiment, the stopper 40 also comprises a controlling valve 42 provided at the opening 200 in such a manner that when the controlling valve 42 is pressed down by an external force to open, the controlling valve 42 allows the filling material selectively flowing into and out of the receiving cavity 14A, 24A, and that when the controlling valve 42 is released to close, the controlling valve 42 is sealed to stop the filling material from flowing into or leaking from the receiving cavity 14A, 24A of the leg rest body 10A or the auxiliary leg rest body 20A. In order to enhance a tightness of the stopper 40, the stopper 40 also comprises a cover 41 which is detachably covered on the controlling valve 42 and a connecting arm 411, wherein the connecting arm 411 is connected between one end of the cover 41 and the controlling valve 42 so that when the cover 41 is opened, it remains connected to the controlling valve 42 through the connecting arm 411.

According to the second preferred embodiment, the leg rest device is adapted for being inflated by the user with mouth or an air pump too. That is to say that, when the user wants to use the leg rest device, she or he may also instantly inflate it with the mouth without the aid of other instruments which make the usage of the leg rest device more convenient. Preferably, each of the leg rest body 10A and the auxiliary leg rest body 20A has a rectangular shape adapted for the leg rest body 10A and the auxiliary leg rest body 20A steadily standing on the ground individually or after connecting the leg rest body 10A on top of the auxiliary leg rest body 20A through the securing means 30A, so as to be fittingly inserted in the gap between the front row seats and the back row seats. In addition, for that the leg rest device is able to be filled by the fluid material such as air, the leg rest device is able to further adjust its overall height by controlling the total amount of air inflated into the leg rest body 10A and/or the auxiliary leg rest body 20A so as to match the height of the adjacent seat to form a flat platform with the seat surface of adjacent seat. Also, the leg rest device is preferred to inflate air until it has a size slight bigger then the gap between the front row seats and the back row seats, so that the leg rest device can be slightly compressed and deformed to fit and secure in the gap between the front row seats and the back row seats to ensure the leg rest device be tightly inserted into such gap to avoid any unwanted movement after it is placed in position. Likewise, both the leg rest body 10A and the auxiliary leg rest body 20A of the leg rest device are able to be embodied as other shapes such as cylindrical shape, square shape and so on.

As shown in FIG. 7, the securing means 30A comprises at least a pair of first and second attaching elements 31A, 32A, such as a pair of hook and loop fasteners (Velcro), adapted for being detachably connected with each other. According to the second preferred embodiment, two first attaching elements 31A are spacedly provided on the first bottom wall 12A of the leg rest body 10A and two second attaching elements 32A are correspondingly provided on the second top wall 21A of the auxiliary leg rest body 20A with respect to the two first attaching elements 31A so that when the leg rest body 10A is disposed on top of the auxiliary leg rest body 20A, the two first attaching elements 31A, such as hook fasteners, are securely and detachably connected to the two second attaching elements 32A, such as loop fasteners so as to connect the leg rest body 10A with the auxiliary leg rest body 20A to form the leg rest device. It is worth mentioning that the two first attaching elements 31A are preferably and spacedly provided near two opposite edges of the first bottom wall 12A of the leg rest body 10A, as shown in FIG. 7.

It is worth to mention that, the first bottom wall 12A the leg rest body 10A is preferred to have the same size as the second top wall 21A of the auxiliary leg rest body 20A, so that when the edges of the first bottom wall 12A of the leg rest body 10A are aligned with the edges of the second top wall 21A of the auxiliary leg rest body 20A, the two first attaching elements 31A will be respectively attached on the corresponding second attaching elements 32A.

Alternatively, if the first bottom wall 12A of the leg rest body 10A has size smaller than the second top wall 21A the auxiliary leg rest body 20A, a pointing line can be provided on the second top wall 21A of the second top wall 21A, so that when the edges of the first bottom wall 12A of the leg rest body 10A are aligned with the edges of the second top wall 21A of the auxiliary leg rest body 20A, the two first attaching elements 31A will also be respectively attached on the corresponding second attaching elements 32A.

Alternatively, if the first bottom wall 12A of the leg rest body 10A has a size bigger than the second top wall 21A of the auxiliary leg rest body 20A, a pointing line can also provide on the first bottom wall 12A of the leg rest body 10A, so that when the edges of the second top wall 21A of the auxiliary leg rest body 20A are aligned with the edges of the first bottom wall 12A of the leg rest body 10A, the two first attaching elements 31A will be respectively attached on the corresponding second attaching elements 32A too. Preferably, each of the first attaching elements 31A and the second attaching elements 32A has an elongated structure, wherein the first and second attaching elements 31A, 32A are respectively provided near the corresponding edges of the first bottom wall 12A of the leg rest body 10A and the corresponding edges of the second top wall 21A of the auxiliary leg rest body 20A.

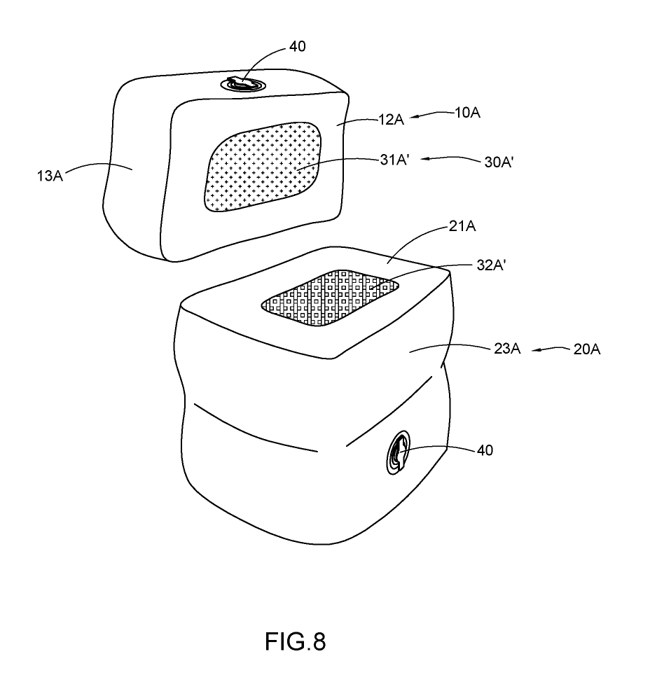

Referring to FIG. 8, an alternative mode of the above second preferred embodiment is illustrated, wherein the securing means 30′ merely comprises one enlarged first attaching element 31A′, such as a hook fastener, and one enlarged second attaching element 32A′, such as a loop fastener, both of which are respectively provided on a central portion of the first bottom wall 12A′ of the leg rest body 10A′ and a central portion of the second top wall 21A′ of the auxiliary leg rest body 20A′, so that the first attaching element 31A′ is aligned for connecting with the second attaching element 32A′ when the leg rest body 10A is placed on top of the auxiliary rest body 20A.

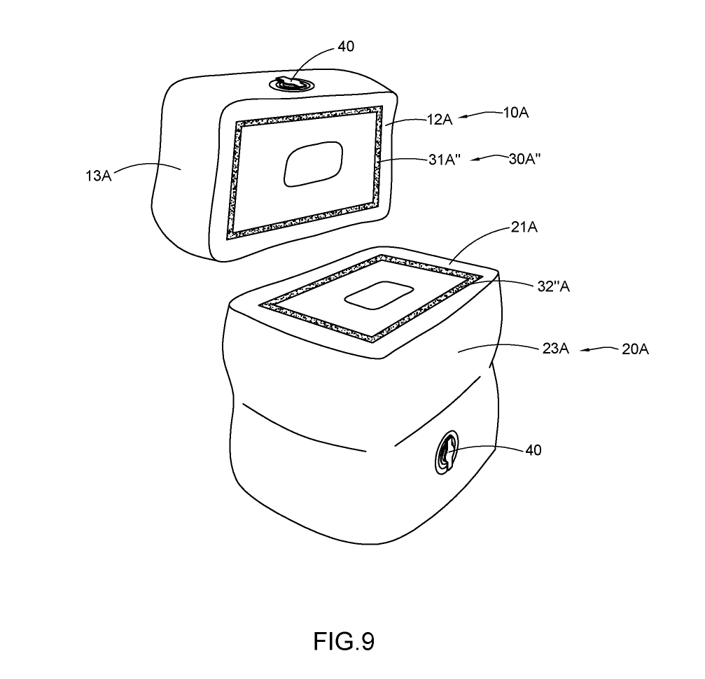

Referring to FIG. 9, another alternative mode of the above second preferred embodiment is illustrated, wherein the securing means 30″ comprises only one first attaching element 31A″, such as a hook fastener, and one second attaching element 32A″, such as a loop fastener, adapted for detachably connecting with the first attaching element 31A″, wherein both of the first attaching element 31A″ and the second attaching element 32A″ are in rectangular ring shape, each extending along the edges the first bottom wall 12A″ of the leg rest body 10A″ and the second top wall 21A″ of the auxiliary leg rest body 20A″ respectively and correspondingly, so that the first attaching element 31A″ is adapted to be connected with the second attaching element 32A″ when the leg rest body 10A is placed on top of the auxiliary leg rest body 20A.

It is appreciated that, the securing means 30, 30′, 30″ may also be embodied to comprise a pair of zipper members, button members or magnetic members, which are able to be connected with each other to connect the first bottom wall 12 of the leg rest body 10A with the second top wall 21A of the auxiliary leg rest body 20A so as to form the leg rest device in layer manner.

It is worth to mention that, the leg rest body 10A and the auxiliary leg rest body 20A are able to be made in different sizes with different heights and sold separately or in combination, wherein the user may one or more leg rest bodies 10A and auxiliary leg rest bodies 20A so that the user may made combination of the leg rest device according to the need and environment requirement.

It is appreciated that each of the leg rest body 10A and auxiliary leg rest body 20A may also comprise a securing means 30, 30′, 30″ which comprises a first attaching element 31A, 31A′, 31A″ on the first or second bottom wall 12A, 22A thereof and a second attaching element 32A, 32A′, 32A″ on the first or second top wall 11A, 21A thereof. Therefore, each of the leg rest body 10A and the auxiliary leg rest body 20A can be connected with two or more leg rest bodies 10A or auxiliary leg rest bodies 20A so as to obtain the desired height of the leg rest device according to the present invention.

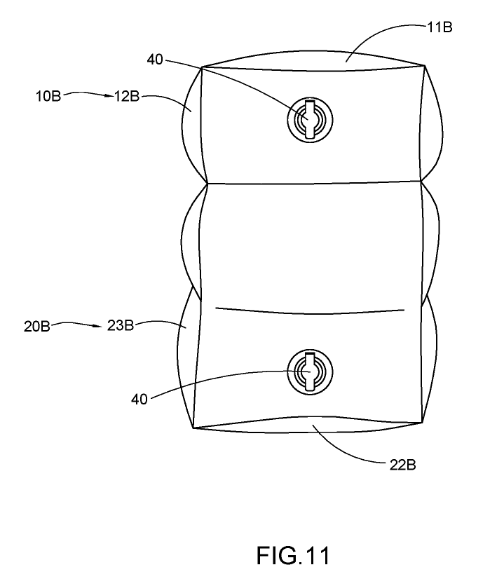

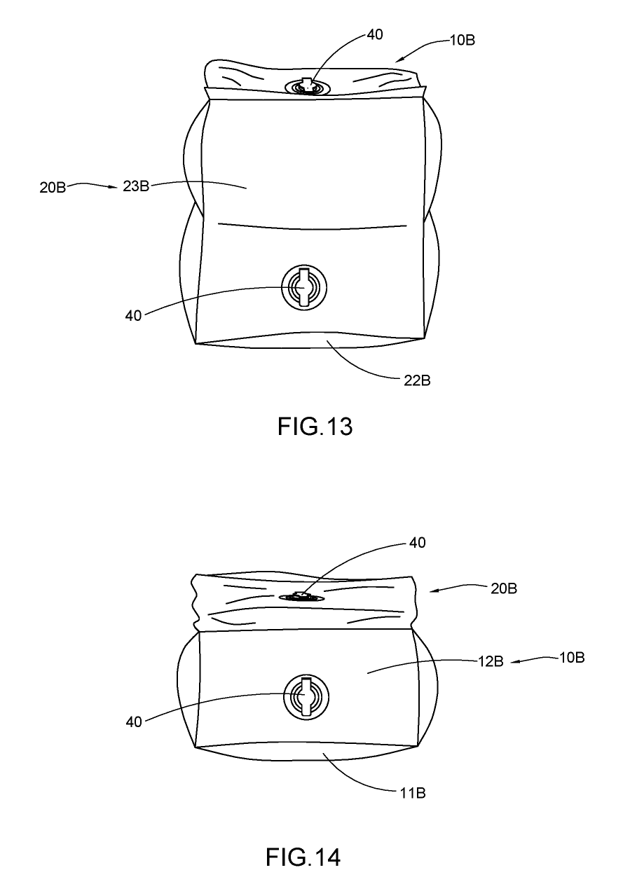

As shown in FIG. 11 to FIG. 14, a leg rest device according to a third preferred embodiment is illustrated, wherein the first bottom wall 12A and the second top wall 21A as described in the above second preferred embodiment are combined to form simply one isolation wall 21B in this third preferred embodiment. According to the third preferred embodiment, the leg rest device comprises a leg rest body 10B and an auxiliary leg rest body 20B, wherein the auxiliary leg rest body 20B comprises an isolation wall 21B, a second bottom wall 22B, and a second surrounding side wall 23B extended between the isolation wall 21B and the second bottom wall 22B to define a second receiving cavity 24B therein for receiving filling material. The base leg rest body 10B comprises a first top wall 11B and a first surrounding side wall 12B extended between the isolation wall 21B and the first top wall 11B to define a first receiving cavity 13 therein for receiving filling material.

It is worth to mention that, the base leg rest body 10A is able to have a same size as the auxiliary leg rest body 20A or a smaller size than the auxiliary leg rest body 20A, or a bigger size than the auxiliary leg rest body 20A. It should not limit by this third preferred embodiment that the base leg rest body 10B has a size smaller than the auxiliary leg rest body 20B.

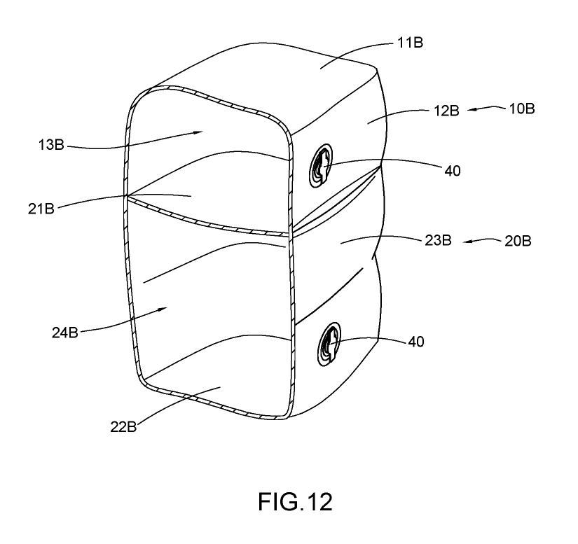

As shown in FIG. 12, the isolation wall 21B is provided between the leg rest body 10B and the auxiliary leg rest body 20B to separate the first receiving cavity 13B from the second receiving cavity 24B, wherein when the user need a higher support, the user can inflate both the leg rest body 10B and the auxiliary leg rest body 20B, and when the user need a relatively lower support later, the user can deflate the base leg rest body 10B while remaining the auxiliary leg rest body 20B be inflated to provide a lower support for the user, or alternatively deflate the auxiliary leg rest body 10B while the base leg rest body 10B remaining be inflated to provide the lowest support for the user. Of course, the user may selectively inflate one of the leg rest body 10B or the auxiliary leg rest body 20A to use.

According to the third preferred embodiment, each of the leg rest body 10B and the auxiliary leg rest body 20B of the leg rest device has an opening 200 for the filling material passing therethrough and a stopper 40, constructed as in the above first and second embodiments, as shown in FIG. 4, for controlling the filling material to flow into or out of the first receiving cavity 13B of the leg rest body 10B and the second receiving cavity 24B of the auxiliary leg rest body 20B respectively.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A leg rest device, comprising at least a leg rest body which comprises a top wall, a bottom wall and a surrounding side wall extended between said top wall and said bottom wall to define a receiving cavity therein for receiving filling material, wherein said leg rest body further has an opening provided for said filling material passing therethrough into said receiving cavity and comprises a stopper provided at said opening adapted for selectively controlling said filling material to flow in and out of said receiving cavity, wherein when said receiving cavity is filled with said filling material, said leg rest body forms a space-structure body having a predetermined height to provide a support for user, and when said filling material is drained out of said receiving cavity, said leg rest body is adapted to be folded up for storing and carrying.

2. The leg rest device, as recited in claim 1, wherein said filling material is air and said stopper further comprises a controlling valve, wherein when said controlling valve is pressed down by an external pressure, said stopper allows said filling material to pass through said opening, and when said controlling valve is released, said stopper stops said filling material from passing through said opening.

3. The leg rest device, as recited in claim 2, wherein said stopper further comprises a cover detachably covered on said controlling valve to enhance a tightness of said stopper.

4. A leg rest device, as recited in claim 1, further comprising at least an auxiliary leg rest body adapted to connect with said leg rest body to form said leg rest device, wherein said auxiliary leg rest body comprises an auxiliary top wall, an auxiliary bottom wall and an auxiliary surrounding wall extended between said auxiliary top wall and said auxiliary bottom wall to define an auxiliary receiving cavity therein for receiving said filling material, wherein said auxiliary leg rest body further has an auxiliary opening provided for said filling material passing therethrough into said auxiliary receiving cavity and comprises an auxiliary stopper provided at said auxiliary opening adapted for selectively controlling said filling material to flow in and out of said auxiliary receiving cavity.

5. The leg rest device, as recited in claim 4, further comprising a securing means, which comprise at least a pair of attaching elements provided on said bottom wall of said leg rest body and said auxiliary top wall of said auxiliary leg rest body adapted to detachably connect with each other so as to connect said leg rest body with said auxiliary leg rest body to form said leg rest device, wherein when said filling material is drained out of said auxiliary receiving cavity of said auxiliary leg rest body while said leg rest body is remained filled with said filling material, said auxiliary height of said auxiliary leg rest body is removed to reduce said overall height of said leg rest device, wherein when said filling material in said receiving cavity of said leg rest body is drained out while said auxiliary leg rest body is remained filled with said filling material, said overall height of said leg rest device is reduced to said auxiliary height, wherein when said filling materials in both said receiving cavity of said leg rest body and said auxiliary cavity of said auxiliary leg rest body are drained out, said leg rest device is adapted to be folded up for storing and carrying.

6. A leg rest device, as recited in claim 2, further comprising at least an auxiliary leg rest body adapted to connect with said leg rest body to form said leg rest device, wherein said auxiliary leg rest body comprises an auxiliary top wall, an auxiliary bottom wall and an auxiliary surrounding wall extended between said auxiliary top wall and said auxiliary bottom wall to define an auxiliary receiving cavity therein for receiving said filling material, wherein said auxiliary leg rest body further has an auxiliary opening provided for said filling material passing therethrough into said auxiliary receiving cavity and comprises an auxiliary stopper provided at said auxiliary opening adapted for selectively controlling said filling material to flow in and out of said auxiliary receiving cavity.

7. The leg rest device, as recited in claim 6, further comprising a securing means, which comprise at least a pair of attaching elements provided on said bottom wall of said leg rest body and said auxiliary top wall of said auxiliary leg rest body adapted to detachably connect with each other so as to connect said leg rest body with said auxiliary leg rest body to form said leg rest device, wherein when said filling material is drained out of said auxiliary receiving cavity of said auxiliary leg rest body while said leg rest body is remained filled with said filling material, said auxiliary height of said auxiliary leg rest body is removed to reduce said overall height of said leg rest device, wherein when said filling material in said receiving cavity of said leg rest body is drained out while said auxiliary leg rest body is remained filled with said filling material, said overall height of said leg rest device is reduced to said auxiliary height, wherein when said filling materials in both said receiving cavity of said leg rest body and said auxiliary cavity of said auxiliary leg rest body are drained out, said leg rest device is adapted to be folded up for storing and carrying.

8. A leg rest device, as recited in claim 3, further comprising at least an auxiliary leg rest body adapted to connect with said leg rest body to form said leg rest device, wherein said auxiliary leg rest body comprises an auxiliary top wall, an auxiliary bottom wall and an auxiliary surrounding wall extended between said auxiliary top wall and said auxiliary bottom wall to define an auxiliary receiving cavity therein for receiving said filling material, wherein said auxiliary leg rest body further has an auxiliary opening provided for said filling material passing therethrough into said auxiliary receiving cavity and comprises an auxiliary stopper provided at said auxiliary opening adapted for selectively controlling said filling material to flow in and out of said auxiliary receiving cavity.

9. The leg rest device, as recited in claim 8, further comprising a securing means, which comprise at least a pair of attaching elements provided on said bottom wall of said leg rest body and said auxiliary top wall of said auxiliary leg rest body adapted to detachably connect with each other so as to connect said leg rest body with said auxiliary leg rest body to form said leg rest device, wherein when said filling material is drained out of said auxiliary receiving cavity of said auxiliary leg rest body while said leg rest body is remained filled with said filling material, said auxiliary height of said auxiliary leg rest body is removed to reduce said overall height of said leg rest device, wherein when said filling material in said receiving cavity of said leg rest body is drained out while said auxiliary leg rest body is remained filled with said filling material, said overall height of said leg rest device is reduced to said auxiliary height, wherein when said filling materials in both said receiving cavity of said leg rest body and said auxiliary cavity of said auxiliary leg rest body are drained out, said leg rest device is adapted to be folded up for storing and carrying.

10. The leg rest device, as recited in claim 5, wherein said filling material is air and said auxiliary stopper further comprises an auxiliary controlling valve, wherein when said auxiliary controlling valve is pressed down by an external pressure, said auxiliary stopper allows said filling material in said auxiliary receiving cavity to pass through said auxiliary opening, and when said auxiliary controlling valve is released, said auxiliary stopper stops said filling material from passing through said auxiliary opening.

11. The leg rest device, as recited in claim 10, wherein said auxiliary stopper further comprises an auxiliary cover detachably covered on said auxiliary controlling valve to enhance a tightness of said auxiliary stopper.

12. The leg rest device, as recited in claim 7, wherein said filling material is air and said auxiliary stopper further comprises an auxiliary controlling valve, wherein when said auxiliary controlling valve is pressed down by an external pressure, said auxiliary stopper allows said filling material in said auxiliary receiving cavity to pass through said auxiliary opening, and when said auxiliary controlling valve is released, said auxiliary stopper stops said filling material from passing through said auxiliary opening.

13. The leg rest device, as recited in claim 12, wherein said auxiliary stopper further comprises an auxiliary cover detachably covered on said auxiliary controlling valve to enhance a tightness of said auxiliary stopper.

14. The leg rest device, as recited in claim 9, wherein said filling material is air and said auxiliary stopper further comprises an auxiliary controlling valve, wherein when said auxiliary controlling valve is pressed down by an external pressure, said auxiliary stopper allows said filling material in said auxiliary receiving cavity to pass through said auxiliary opening, and when said auxiliary controlling valve is released, said auxiliary stopper stops said filling material from passing through said auxiliary opening.

15. The leg rest device, as recited in claim 14, wherein said auxiliary stopper further comprises an auxiliary cover detachably covered on said auxiliary controlling valve to enhance a tightness of said auxiliary stopper.

16. The leg reset device, as recited in claim 4, wherein said bottom wall of said leg rest body and said auxiliary top wall of said auxiliary leg rest body is an insolation wall formed between said leg rest body and said auxiliary leg rest body such that said leg rest body and said auxiliary leg rest body are integrally is an integral space-structure body having said receiving cavity isolated with said auxiliary receiving cavity by said isolation wall, wherein when said filling material is drained out of said auxiliary receiving cavity of said auxiliary leg rest body while said leg rest body is remained filled with said filling material, said auxiliary height of said auxiliary leg rest body is removed to reduce said overall height of said leg rest device, wherein when said filling material in said receiving cavity of said leg rest body is drained out while said auxiliary leg rest body is remained filled with said filling material, said overall height of said leg rest device is reduced to said auxiliary height, wherein when said filling materials in both said receiving cavity of said leg rest body and said auxiliary cavity of said auxiliary leg rest body are drained out, said leg rest device is adapted to be folded up for storing and carrying.

17. The leg reset device, as recited in claim 6, wherein said bottom wall of said leg rest body and said auxiliary top wall of said auxiliary leg rest body is an insolation wall formed between said leg rest body and said auxiliary leg rest body such that said leg rest body and said auxiliary leg rest body are integrally is an integral space-structure body having said receiving cavity isolated with said auxiliary receiving cavity by said isolation wall, wherein when said filling material is drained out of said auxiliary receiving cavity of said auxiliary leg rest body while said leg rest body is remained filled with said filling material, said auxiliary height of said auxiliary leg rest body is removed to reduce said overall height of said leg rest device, wherein when said filling material in said receiving cavity of said leg rest body is drained out while said auxiliary leg rest body is remained filled with said filling material, said overall height of said leg rest device is reduced to said auxiliary height, wherein when said filling materials in both said receiving cavity of said leg rest body and said auxiliary cavity of said auxiliary leg rest body are drained out, said leg rest device is adapted to be folded up for storing and carrying.

18. The leg reset device, as recited in claim 8, wherein said bottom wall of said leg rest body and said auxiliary top wall of said auxiliary leg rest body is an insolation wall formed between said leg rest body and said auxiliary leg rest body such that said leg rest body and said auxiliary leg rest body are integrally is an integral space-structure body having said receiving cavity isolated with said auxiliary receiving cavity by said isolation wall, wherein when said filling material is drained out of said auxiliary receiving cavity of said auxiliary leg rest body while said leg rest body is remained filled with said filling material, said auxiliary height of said auxiliary leg rest body is removed to reduce said overall height of said leg rest device, wherein when said filling material in said receiving cavity of said leg rest body is drained out while said auxiliary leg rest body is remained filled with said filling material, said overall height of said leg rest device is reduced to said auxiliary height, wherein when said filling materials in both said receiving cavity of said leg rest body and said auxiliary cavity of said auxiliary leg rest body are drained out, said leg rest device is adapted to be folded up for storing and carrying.

19. The leg rest device, as recited in claim 16, wherein said filling material is air and said auxiliary stopper further comprises an auxiliary controlling valve, wherein when said auxiliary controlling valve is pressed down by an external pressure, said auxiliary stopper allows said filling material in said auxiliary receiving cavity to pass through said auxiliary opening, and when said auxiliary controlling valve is released, said auxiliary stopper stops said filling material from passing through said auxiliary opening.

20. The leg rest device, as recited in claim 19, wherein said auxiliary stopper further comprises an auxiliary cover detachably covered on said auxiliary controlling valve to enhance a tightness of said auxiliary stopper.

21. The leg rest device, as recited in claim 17, wherein said filling material is air and said auxiliary stopper further comprises an auxiliary controlling valve, wherein when said auxiliary controlling valve is pressed down by an external pressure, said auxiliary stopper allows said filling material in said auxiliary receiving cavity to pass through said auxiliary opening, and when said auxiliary controlling valve is released, said auxiliary stopper stops said filling material from passing through said auxiliary opening.

22. The leg rest device, as recited in claim 21, wherein said auxiliary stopper further comprises an auxiliary cover detachably covered on said auxiliary controlling valve to enhance a tightness of said auxiliary stopper.

23. The leg rest device, as recited in claim 18, wherein said filling material is air and said auxiliary stopper further comprises an auxiliary controlling valve, wherein when said auxiliary controlling valve is pressed down by an external pressure, said auxiliary stopper allows said filling material in said auxiliary receiving cavity to pass through said auxiliary opening, and when said auxiliary controlling valve is released, said auxiliary stopper stops said filling material from passing through said auxiliary opening.

24. The leg rest device, as recited in claim 23, wherein said auxiliary stopper further comprises an auxiliary cover detachably covered on said auxiliary controlling valve to enhance a tightness of said auxiliary stopper.
